(19) United States
(12) Patent Application Publication
(10) Pub. No.: US 2005/0286490 A1
(43) Pub. Date: Dec. 29, 2005

(54) Method for automatically selecting lowest rate for dialing phone call via wireless telecommunication device

(75) Inventors: Tony Tsai, Taipei Hsien (TW); David Ho, Taipei Hsien (TW); Jie Lin, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,200

(22) Filed: Jun. 23, 2004

(51) Int. Cl. H04L 12/28

(52) U.S. Cl. 370/352; 370/395.21

(57) ABSTRACT

The present invention discloses a method for automatically selecting the lowest rate for dialing a phone call via a wireless telecommunication device, which is implemented within a wireless telecommunication device, a wireless network and at least one Internet phone service provider, and enables the wireless telecommunication device to download the latest phone rate from each Internet phone service provider through a wireless network and store the lowest rate into a data storage medium thereof so that, if a phone call is made via the wireless telecommunication device, a central processor thereof will automatically find the lowest rate stored in the data storage medium as the main determination basis for selecting the Internet phone service provider.

### FIELD OF THE INVENTION

The present invention relates to a method for automatically selecting the lowest rate for dialing a phone call via a wireless telecommunication device, more particularly to a method enabling a wireless telecommunication device to download the latest phone rate from each Internet phone service provider through a wireless network and store the lowest rate into a data storage medium thereof so that, if a phone call is made via the wireless telecommunication device, a central processor thereof will automatically find the lowest rate stored in the data storage medium as the main determination basis for selecting the Internet phone service provider.

### BACKGROUND OF THE INVENTION

As the rise of extensive applications of Internet, the Internet phone (IP) creates a tremendous impact on the traditional telephone industry by its low telephone rate and promising market prospective. Within a short period of two years, the Internet phones spread all over the world rapidly, so that all major telecommunication device manufacturers and service providers invest huge amount of money in the area of Internet phone. Many famous market analysts repeatedly make predictions on the excellent development of the IP market.

The Internet phone (i-phone) makes use of Internet to transmit voices, which is similar to making a phone call. Using an i-phone to make an international call, the charge rate will be based on the rate for making local calls. Therefore, the i-phone can save a big amount of telephone costs. The theory of Internet phone operation is to convert an analog audio signal into a digital signal, and then enter the digital signal into a computer, and the computer converts the digital signal into a packet for transmission. The receiving end of the computer converts the packet into voice. Therefore, both of the caller and the receiver must have basic computer equipments including a sound card, a speaker, a microphone, a modem, and an account (for dialup users). If the cost of these equipments is not included for the calculation, i-Phone is considered to be the cheapest way of making international calls.

As the telecommunication industry blooms, our daily life is impacted greatly and people are attached to communications almost every second. Undoubtedly, the development trend of the world closely integrates our life with the wireless terminal, fixed network (fixed telecommunication network service), and computer network. The wireless terminals (such as mobile phone) have the fastest growth per year in the telecommunication industry. Therefore, we can foresee that the importance of mobile phone goes far beyond the fixed type telephone. Therefore, the trend of telecommunication companies tends to provide a total solution and more add-on values to mobile phones such as offering the functions of providing financial quotations, weather information, stock information, and sending or receiving emails.

Therefore, using a mobile phone to dial an Internet phone to save telephone cost is a mainstream of telecommunication application now. In general, mobile phone users can apply for several Internet phone accounts from different service providers. A user will select a service provider of the lowest rate to dial an Internet phone call. Since each Internet phone service provider changes the rate from time to time, the mobile phone user needs to collect the most updated information on the telephone rates of each Internet phone service provide all the time, which will keep mobile phone users constantly on the run. Users are expecting to have a method to help them to actively select the lowest rate among the most updated rates provided by different Internet phone service providers. Such arrangement is definitely a great contribution to the extensive consumers.

### SUMMARY OF THE INVENTION

In view of the wireless technology, personal computer, personal digital assistant and telephone tending to be developed as wireless and the functions of wireless network are enhanced, the data of the foregoing wireless network can be transmitted among different wireless equipments. Therefore, the present invention is created based on this idea. Since the competition among wireless terminal manufacturers is very severe, therefore any consideration design for the consumers may become a key factor of bring in successful sales. To overcome the shortcomings of the prior art, the inventor of the present invention conducted extensive researches and experiments and finally invented a method of automatically selecting the lowest rate for dialing an Internet phone call via a wireless telecommunication device.

The primary objective of the present invention is to automatically find the lowest rate for dialing an Internet phone call via a wireless telecommunication device as a main determination basis for selecting the Internet phone service providers which mainly include the wireless telecommunication device, a wireless network, and a modem service provider; wherein the wireless telecommunication device comprises a central processor, an automatic determination program, and a data storage medium, so that the wireless telecommunication device is linked to the modem service provider by the wireless network, and thus the modem service provider can provide the latest phone rate of each Internet phone service provider to the wireless telecommunication device, and overwrites the old phone rate stored in the data storage medium. If a phone call is made via the wireless telecommunication device, the central processor will use the automatic determination program to find the lowest rate stored in the data storage medium as the main determination basis for selecting the Internet phone service provider.

The above and other objects, features and advantages of the present invention will become apparent from the following detailed description taken with the accompanying drawings.

### BRIEF DESCRIPTION OF THE DRAWINGS

FIG. 1 is a planar view of the present invention.

FIG. 2 is another planar view of the present invention.

### DETAILED DESCRIPTION OF THE PREFERRED EMBODIMENTS

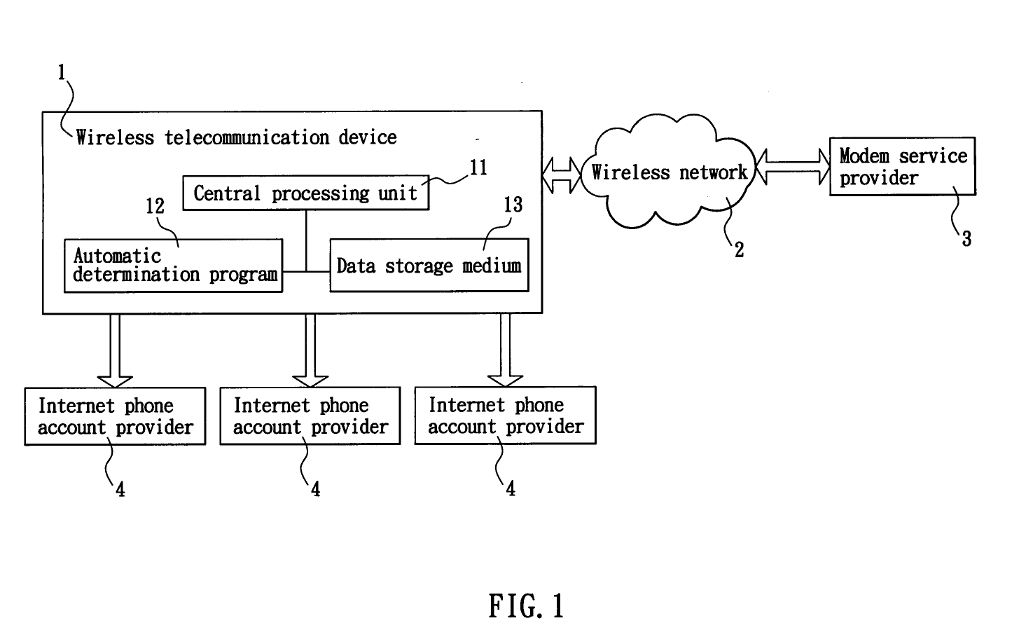

The invention discloses a method of automatically selecting the lowest rate for dialing an Internet phone call via a wireless telecommunication device. Please refer to FIG. 1 for the present invention which includes a wireless telecommunication device 1 (such as a mobile phone), a wireless network 2, and a modem service provider 3; wherein the wireless telecommunication device 1 comprises a central processor 11, an automatic determination program 12 and a data storage medium 13, so that the wireless telecommunication device 1 can be linked to the modem service provider 3 by the wireless network 2 for providing the most updated telephone rate of each Internet phone service provider to the wireless telecommunication device 1 to update the old telephone rates stored in the data storage medium 13, and thus when a phone call is dialed via the wireless telecommunication device 1, the central processor 11 will use the automatic determination program 12 to find the lowest rate in the data storage medium 13 as the main determination basis for selecting the Internet phone service provider 4.

Please refer to FIG. 1 for the present invention. After the central processor 11 uses the automatic determination program 12 to automatically find the lowest rate in the data storage medium 13, the prefix code of the Internet phone service provider having the lowest rate will appear on a screen display of the wireless telecommunication device 1. Therefore, the user of the wireless telecommunication device 1 just needs to enter the desire phone number behind the prefix code. For example, the data storage medium 13 stores the information on Northeastern Telecom Company (Prefix Code: 0999), First Telecom Company (Prefix Code: 0988), and Outstanding Telecom Company (Prefix Code 0977). If the user of the wireless telecommunication device 1 wants to make a phone call via an Internet phone to Shanghai (Area Code: 021) and Mr. Wang's telephone number is 87654321, the central processor 11 uses the automatic determination program 12 to automatically find the lowest rate in the data storage medium 13, and it is assumed that Northeastern Telecom Company has the lowest rate, the central processor 11 will show the prefix code “0999” directly on the screen display of the wireless telecommunication device 1. The user of the wireless telecommunication device 1 just needs to enter “021” and “87654321” behind “0999” to make a phone call to Mr. Want in Shanghai.

The modem service provider 3 according to the invention as shown in FIG. 1 sends a short text message to the wireless telecommunication device 1 to notice the user of the wireless telecommunication device 1 about the latest information of the phone rates, so that the user of the wireless telecommunication device 1 can immediately logon the website of the modem service provider 3 to download the most updated phone rate; wherein the short text message could be an enhanced message service (EMS) or a short message service (SMS).

Further, the automatic determination program 12 of the invention as shown in FIG. 1 can automatically update the latest phone rates from the website of the modem service provider 3 via the wireless network 2 within a fixed period of time (such as a month, two weeks, or one week set or modified by the users according to actual needs).

The wireless network 2 of the invention as shown in FIG. 1 could be a global system for mobile communication (GSM) or a general packet radio service (GPRS).

The communication protocol used among the wireless telecommunication device 1, the wireless network 2 and the modem service provider 3 according to the invention as shown in FIG. 1 could be a wireless application protocol (WAP).

With the description of a profound idea in simple language, it is believed that our examiner should be familiar with the invention already. The following real-life example is given to let our examiner have a better understanding about the invention.

For example, the telephone charges of the following companies are listed below:
For First Telecom Company,
Domestic Long-Distance Call: $0.30/minute; and
International Long-Distance Call: $2.60/minute.
For Northeastern Telecom Company,
Domestic Long-Distance Call: $0.60/minute; and
International Long-Distance Call: $2.50/minute.
For Outstanding Telecom Company,
Domestic Long-Distance Call: $0.70/minute; and
International Long-Distance Call: $2.40/minute.

Therefore, if the user of a wireless telecommunication device 1 wants to dial a domestic long-distance call via an Internet phone, the central processor 1 will use an automatic determination program 12 to find the lowest rate (Northeastern Telecom Company has a rate of $0.30/minute) in the data storage medium 13. If the user of the wireless telecommunication device 1 wants to dial an international long-distance call via the Internet phone, the central processor 11 uses the automatic determination program 12 to find the lowest rate (Outstanding Telecom Company has a rate of $2.40/minute) in the data storage medium 13.

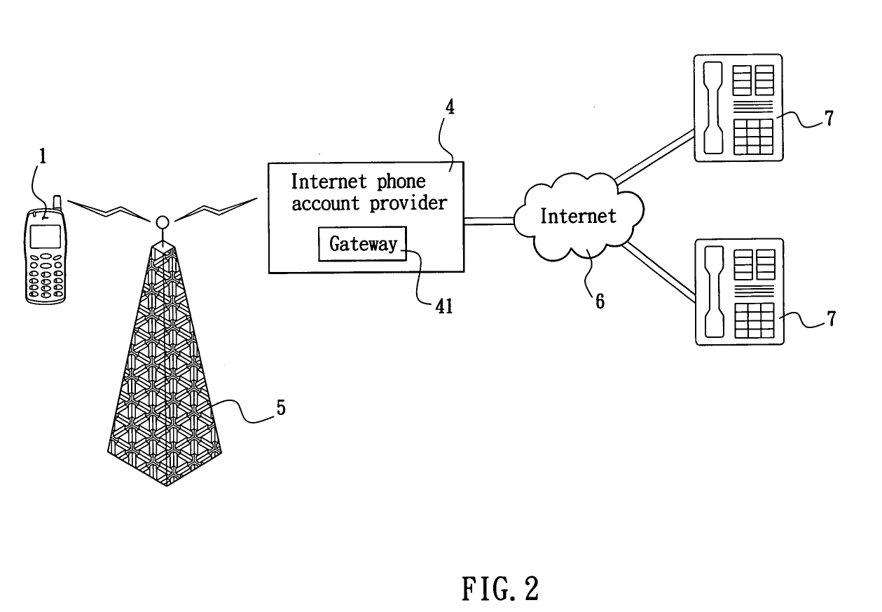

The Internet phone service provider 4 of the invention as shown in FIG. 2 installs an Internet protocol gateway 41, and such Internet protocol gateway 41 is connected to the Internet 6, such that when the user of the wireless telecommunication device 1 wants to dial a call via an Internet phone, the wireless telecommunication device 1 can be connected to the Internet protocol gateway 41 through a base station 5, and then connected to Internet 6 in order to connect a remote telecommunication server 7.

While the invention has been described by means of specific embodiments, numerous modifications and variations could be made thereto by those skilled in the art without departing from the scope and spirit of the invention set forth in the claims.

1. A method for automatically selecting lowest rate for dialing Internet phone via wireless telecommunication device, which is implemented within a wireless telecommunication device, a wireless network, and a modem service provider; wherein said wireless telecommunication device further comprising a central processor, an automatic determination program and a data storage medium, thereby said wireless telecommunication device being connected to said wireless network and said modem service provider, and said modem service provider providing the latest phone rate of different Internet phone service providers to said wireless telecommunication device in order to update an old phone rate stored in said data storage medium; and the procedure taken by said central processor when said wireless telecommunication device is selected for dialing an Internet phone call comprising the steps of:
receiving an instruction for dialing an Internet phone call; and
using said automatic determination program to find the lowest rate in said data storage medium.

2. The method of claim 1, wherein said central processor uses said automatic determination program to automatically find the lowest rate in said data storage medium, and directly shows a prefix code of an Internet phone service provider having said lowest rate on a screen display.

3. The method of claim 1, wherein said modem service provider sends a short text message to said wireless telecommunication device to notice about an updated information of said phone rate, such that said wireless telecommunication device immediately logon a website of said modem service provider to download said updated phone rate.

4. The method of claim 3, wherein said short text message is an enhanced message service.

5. The method of claim 3, wherein said short text message is a short message service.

6. The method of claim 1, wherein said automatic determination program makes said wireless telecommunication device to automatically download said updated phone rate from said wireless network within a predetermined time.

7. The method of claim 1, wherein said wireless network is a global system for mobile communication (GSM).

8. The method of claim 1, wherein said wireless network is a general packet radio service (GPRS).

9. The method of claim 1, wherein said telecommunication protocol used among said wireless mobile phone, wireless network and modem service provider is a wireless application protocol (WAP).

10. The method of claim 1, wherein said wireless telecommunication device network is a mobile phone.
